(19) United States
(12) Patent Application Publication
(10) Pub. No.: US 2008/0174504 A1
(43) Pub. Date: Jul. 24, 2008

(54) REFLECTOR ANTENNA FEED DEVICE

(75) Inventors: Denis TUAU, Trignac (FR); Armel Le Bayon, St Brevin les Pins (FR)

Correspondence Address: SUGHRUE MION, PLLC, 2100 PENNSYLVANIA AVENUE, N.W., SUITE 800, WASHINGTON, DC, 20037, US

(73) Assignee: Alcatel Lucent, Paris (FR)

(21) Appl. No.: 11/945,721

(22) Filed: Nov. 27, 2007

(30) Foreign Application Priority Data
Nov. 29, 2006 (FR) 0655173

(51) Int. Cl. H01Q 19/10

(52) U.S. Cl. 343/755

(57) ABSTRACT

The antenna feed device (4) of the invention comprises a reflector (2) into which a circular or rectangular section waveguide (8) opens out, the waveguide including a cylindrical or conical radiating aperture (10, 9) at its end. A lens (22) of dielectric material is inserted in part into the inside of the aperture, the portion (23) of the lens (22) projecting out from the waveguide (8) being substantially in the form of a truncated cone and having its smaller diameter end (24) facing outwards. The end (24) includes a central cavity (25) of shape that is given by the solution to a polynomial equation of the “b+ax+cx²+dx³” type, or to a logarithmic equation.

The present invention relates to a reflector antenna for telecommunications, as used in particular for mobile communications networks. The invention relates in particular to the feed device of such an antenna.

### BACKGROUND OF THE INVENTION

An antenna with a conventional radiating aperture comprises a reflector presenting a concave surface, e.g. in the form of a paraboloid of revolution about the axis of symmetry of the antenna, and a feed device conveying the electromagnetic waves transmitted or received by the antenna. The antenna feed device is situated on the axis of symmetry of the antenna on the concave side of the reflector and presents, like the antenna as a whole, circular symmetry about said axis. The feed device of the antenna comprises a waveguide that may be of rectangular section or circular section with a radiating aperture that may be conical or cylindrical. Nevertheless, such antennas provide a primary radiation spectrum of poor performance. In order to improve performance, a cylindrical wall or skirt that is usually covered on the inside in an absorbent coating is added around the reflector in order specifically to limit side radiation. Those antennas present high levels of spill-over loss, and it is necessary to use a skirt of considerable height.

U.S. Pat. No. 4,673,945 describes an antenna having a waveguide placed in a conductive tube and having a conical end that projects out from the tube, forming a concave surface covered in a conductive layer. That leads to an increase in gain and to a reduction in side lobes.

US patent No. 2003/0 184 486 describes a feed device for an antenna with a parabolic reflector, the feed device comprising a hollow waveguide of circular section having its radiating end filled with a bar of dielectric material. The outside end of the bar is covered by a cap so as to reflect waves towards the main reflector.

The article by A. A. Kischk (IEE Proceedings, 136(2), 1989, pp. 169-171) describes an antenna with a parabolic reflector and having a circular section waveguide. In order to reduce the size of the radiating aperture, the waveguide is filled with a bar of dielectric material such as plexiglass. The bar projects from the aperture of the waveguide over a length of 0.15λ. The pointed cone shape of the end of the dielectric bar is determined so as to diminish cross-polarization.

### OBJECTS AND SUMMARY OF THE INVENTION

An object of the present invention is to eliminate the drawbacks of the prior art, and in particular to improve the primary radiation spectrum of the antenna by reducing its side lobes and its dependency on frequency.

Another object of the invention is to provide a feed device for a reflector antenna that increases performance of the antenna in terms of cross-polarization and gain.

Another object of the invention is to provide an antenna that requires a skirt of smaller height.

The present invention provides a device for feeding an antenna comprising a reflector into which there opens out a waveguide of circular or rectangular section and having at its end a cylindrical or conical radiating aperture. According to the invention, a lens of dielectric material is inserted in part into the inside of said aperture. The portion of the lens that projects from the waveguide is substantially in the form of a truncated cone with its smaller diameter end facing outwards. This end has a central cavity of shape given by the solution of a polynomial equation of the “b+ax+cx²+dx³” type or to a logarithmic equation.

In a first embodiment of the device of the invention, the portion of the lens projecting from the waveguide is substantially in the form of a truncated cone of greatest diameter lying in the range 0.5λ to λ, where λ is the length of the electromagnetic wave. Preferably, the greatest diameter is about 0.85λ.

In a second embodiment, the portion of the lens projecting from the waveguide is substantially in the form of a truncated cone of smallest diameter lying in the range 0.5λ to 0.9λ, where λ is the length of the guided electromagnetic wave. Preferably, the smallest is about 0.70λ.

In a third embodiment, the length of the portion of the lens situated outside the waveguide lies in the range 0.4λ to 0.7λ, where λ is the length of the electro-magnetic wave. Preferably, the length is about 0.55λ.

In a particular embodiment of the invention, the central cavity of the lens is extended by vertical edges of height lying in the range 0.04λ to 0.1λ, where λ is the length of the guided electromagnetic wave. The height of the vertical edges is preferably about 0.07λ.

In a variant embodiment, a trap is associated with said lens. The presence of the trap creates a masking effect that hides a portion of the signal, but that avoids spill-over losses and improves the primary radiation pattern of the antenna. The trap associated with the lens is preferably a “quarterwave” trap. Instead of the trap, it would also be possible to use a ring of dielectric material contributing to reducing the side lobes.

The invention also provides a reflector antenna comprising a feed device including a reflector into which there opens out a waveguide of circular or rectangular section having a cylindrical or conical radiating aperture at its end. A lens of dielectric material is inserted in part inside said aperture. The portion of the lens projecting out from the waveguide is substantially in the shape of a truncated cone. Its smaller diameter end faces outwards, said end including a central cavity of shape given by the solution to a polynomial equation of the “b+ax+cx²+dx³” type, or to a logarithmic equation.

The present invention has the advantage of increasing the gain and the cross-polarization performance of the antenna. In addition, the invention makes it possible to use a skirt of smaller height, thereby reducing the overall size of the antenna.

### BRIEF DESCRIPTION OF THE DRAWINGS

Other characteristics and advantages of the present invention appear on reading the following description of embodiments, naturally given by way of non-limiting illustration, and from the accompanying drawings, in which:

FIGS. 1A and 1B are sections of conventional antennas;

FIG. 2 is an oblique section view showing the aperture of a waveguide provided with a lens of the present invention;

FIG. 3 is a section view showing a variant embodiment of the invention;

FIG. 4 comprises a section view and a perspective view of a quarterwave trap; and

FIGS. 5A and 5B compare the primary radiation spectra respectively in a horizontal polarization plane and in a vertical polarization plane of an antenna fitted with a conventional feed device including a trap, and also of an antenna provided with a feed device of the invention.

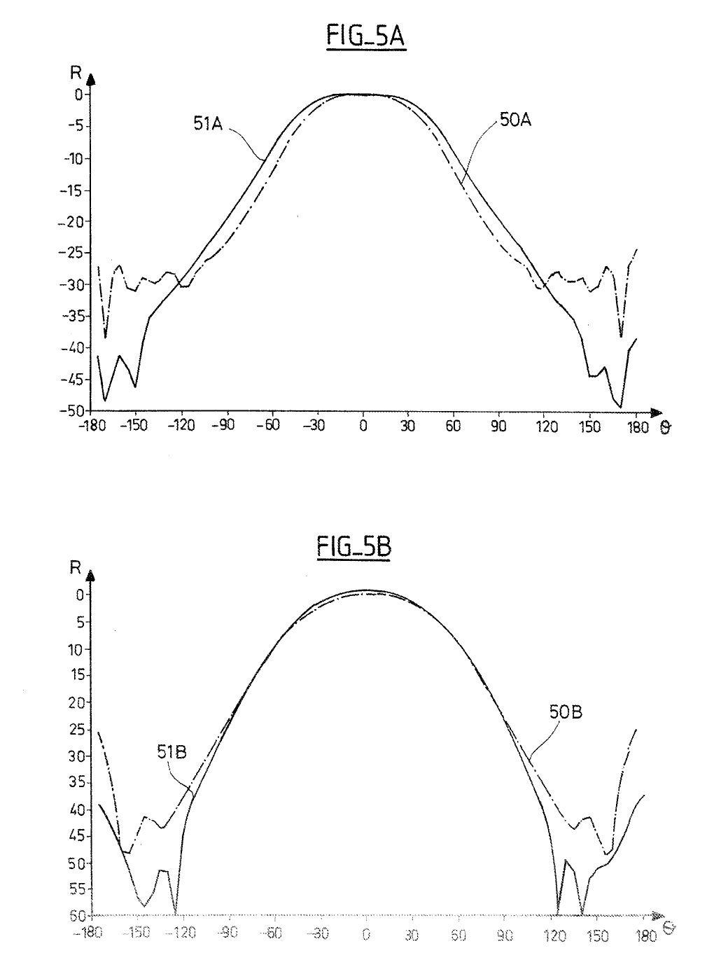

In FIGS. 5A and 5B, radiation R is plotted in decibels (dB) up the ordinate, and angle θ relative to the axis of the antenna is plotted in degrees along the abscissa.

### MORE DETAILED DESCRIPTION

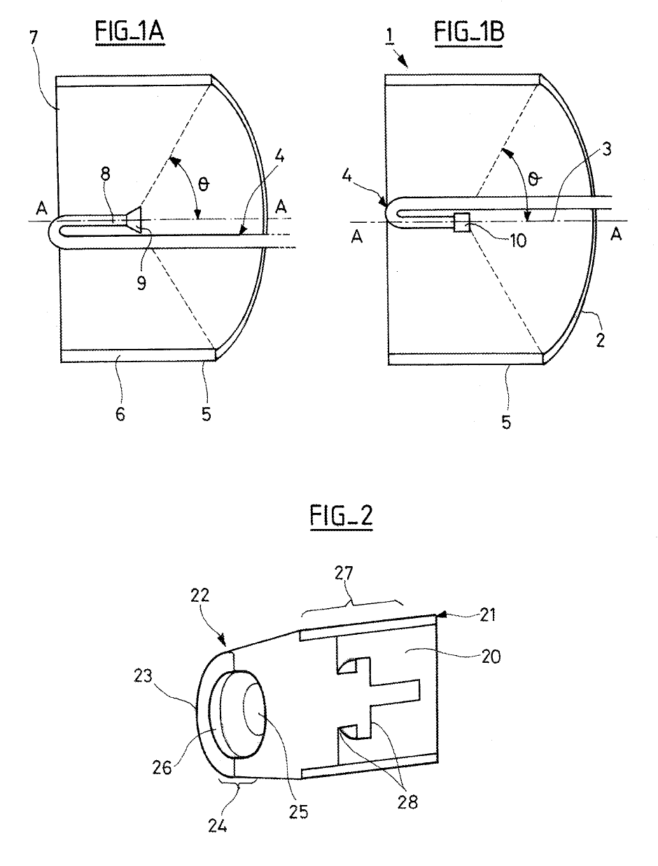

A prior art antenna 1 shown in FIG. 1 comprises a reflector 2 presenting a concave surface, e.g. in the form of a paraboloid of revolution about an axis of symmetry A-A 3 of the antenna 1, and a feed device 4 conveying the electromagnetic waves transmitted and received by the antenna 1. To improve the performance of the antenna 1, the antenna is provided with a cylindrical wall or skirt 5 that is covered internally with an absorbent coating 6 serving to limit side radiation in particular. The presence of the skirt 5 increases the wind resistance of the antenna 1 and runs the risk of accumulating elements such as water, dust, or snow. It is also known to arrange a radome 7 on the skirt 5, which radome presents a plane protective surface closing off the space defined by the reflector 2 and the skirt 5 from elements external to the antenna.

Electromagnetic waves are conveyed within the antenna 1 by means of a waveguide 8 conventionally made of metal, e.g. brass or aluminum. The waveguide 8 may be of rectilinear or circular section, with a conical radiating aperture 9 as shown in FIG. 1A or with a cylindrical radiating aperture 10 as shown in FIG. 1B.

In the embodiment of the invention shown in oblique section in FIG. 2, there can be seen the cylindrical aperture 20 of a waveguide 21 within which there is inserted a portion of a lens 22 in such a manner that a portion 23 of the lens projects out from the waveguide. This portion 23 is substantially in the shape of a cone from which the tip has been cut off. The smaller diameter, narrow end 24 of the portion 23 faces outwards, and includes a central cavity 25 of a particular shape given by the solution to a polynomial equation of the type “b+ax+cx²+dx³” or to a logarithmic equation. The central cavity 25 is extended by vertical edges 26 of height lying in the range 0.04λ to 0.1λ, and preferably of about 0.07λ, where λ is the length of the guided electromagnetic wave. For a microwave antenna, the length of the guided electromagnetic wave usually lies in the range 10 millimeters (mm) to 50 mm.

The projecting portion 23 of the lens 22 is substantially conical in shape having its largest diameter D lying in the range 0.7λ and λ, and preferably equal to about 0.85λ, and having its smallest diameter d lying in the range 0.5λ to 0.9λ, and preferably equal to about 0.70λ. The length H of the portion 23 of the lens 22 that projects from the waveguide 21 lies in the range 0.4λ and 0.7λ, and is preferably about 0.55λ.

The other portion 27 of the lens 22 that is placed in the aperture 20 of the waveguide 21 presents a succession of steps 28.

The lens 22 is preferably made of a low loss dielectric material that is relatively insensitive to frequency in the range under consideration. The material may be selected in particular from a polystyrene, such as “REXOLITE”, from the supplier “C-LEC”, or a polymethyl methacrylate (PMMA).

The total wavelength of the antenna lie in the range 25λ to 200λ.

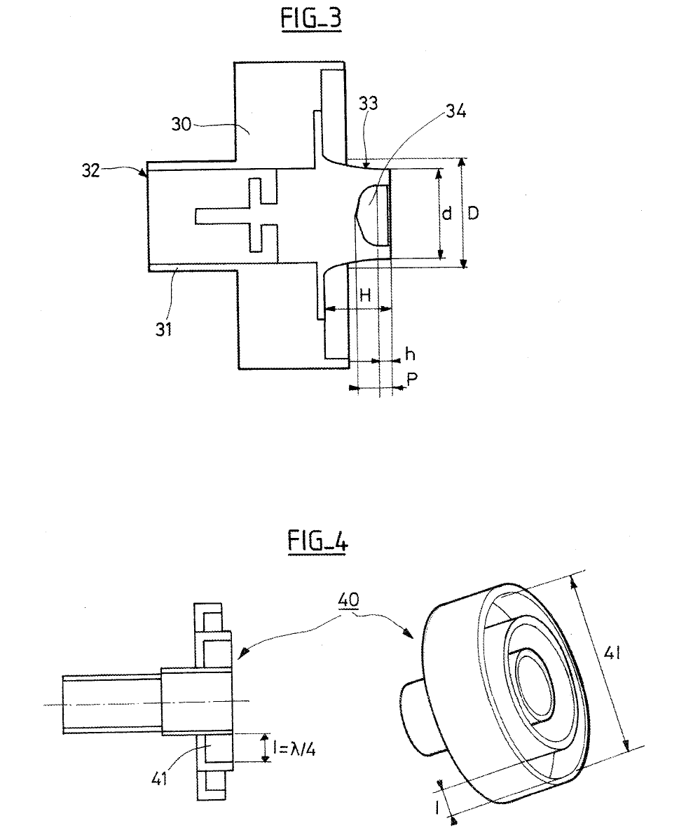

Reference is given below to FIG. 3 which shows another embodiment of the present invention. A quarterwave (λ/4) type trap 30 is placed at the end 31 of a hollow waveguide 32. A lens 33 of shape substantially analogous to that of FIG. 2 is inserted in part inside the end of the waveguide 32. The presence of the trap 40 creates a masking effect that hides a portion of the signal, but that avoids spill-over losses and improves the primary radiation pattern of the antenna. Instead of the trap, it would also be possible to use a ring of dielectric material that contributes to reducing side lobes.

Another example of a trap 40 of this type is shown in section and in perspective in an enlarged view in FIG. 4. Each of the four compartments 41 that it includes presents a width l equal to λ/4, i.e. a quarter of a wavelength.

FIGS. 5A and 5B serve to compare the performance obtained with a conventional antenna provided with a trap (curves 50A and 50B) with the performance obtained with an antenna fitted with a lens constituting an embodiment of the invention (curves 51A and 51B), respectively in the horizontal polarization plane and in the vertical polarization plane.

This comparison between the primary radiation spectra of a conventional antenna with a trap and an antenna constituting an embodiment of the present invention reveals the following advantages.

1) The primary radiation spectrum is very similar in both the horizontal and the vertical polarization planes.

2) The level of the field radiated by the primary source onto the main reflector is uniform and almost constant (also said to be “flat”) over an angle θ=+30° to θ=−30° C. relative to the axis of the reflector.

3) The field level is reduced for θ>100° and for θ<−100°. These values for the angle θ correspond to primary source illumination not on the reflector, but on the skirt. When the field level is high in this range of angles, a taller skirt is needed to eliminate undesirable reflections.

What is claimed is:

1. A device for feeding an antenna comprising a reflector (2) into which there opens out a waveguide (8) of circular or rectangular section and having at its end a cylindrical or conical radiating aperture (10 or 9), a lens (22) of dielectric material being inserted in part into the inside of said aperture, the device being characterized in that the portion (23) of the lens that projects from the waveguide is substantially in the form of a truncated cone with its smaller diameter end (24) facing outwards, said end (24) having a central cavity (25) of shape given by the solution of a polynomial equation of the “b+ax+cx²+dx³” type or to a logarithmic equation.

2. A device according to claim 1, in which the portion (23) of the lens projecting from the waveguide is substantially in the form of a truncated cone of greatest diameter D lying in the range 0.5λ to λ, where λ is the length of the electromagnetic wave.

3. A device according to claim 2, in which the greatest diameter D is about 0.85λ.

4. A device according to claim 1, in which the portion (23) of the lens projecting from the waveguide is substantially in the form of a truncated cone of smallest diameter d lying in the range 0.5λ to 0.9λ, where λ is the length of the electromagnetic wave.

5. A device according to claim 4, in which the smallest diameter d is about 0.70λ.

6. A device according to claim 1, in which the length H of the portion (23) of the lens situated outside the waveguide lies in the range 0.4λ to 0.7λ, where λ is the length of the electromagnetic wave.

7. A device according to claim 6, in which the length H is about 0.55λ.

8. A device according to claim 1, in which the central cavity (34) of the lens is extended by vertical edges of height h lying in the range 0.04λ to 0.1λ, where λ is the length of the electromagnetic wave.

9. A device according to claim 8, in which the height h of the vertical edges is about 0.07λ.

10. A device according to claim 1, in which a trap (40) is associated with said lens.

11. A device according to claim 10, in which the trap associated with said lens is a so-called “quarterwave” trap.

12. A reflector antenna comprising a feed device (4) including a reflector (2) into which there opens out a waveguide (8) of circular or rectangular section having a cylindrical or conical radiating aperture at its end, a lens (22) of dielectric material being inserted in part inside said aperture, the portion (23) of the lens projecting out from the waveguide being substantially in the shape of a truncated cone and having its smaller diameter end (24) facing outwards, said end (24) including a central cavity (25) of shape given by the solution to a polynomial equation of the “b+ax+cx²+dx³” type, or to a logarithmic equation.
